(19) United States
(12) Patent Application Publication
(10) Pub. No.: US 2026/0369259 A1
(43) Pub. Date: Nov. 19, 2026

(54) NOISE REDUCTION METHOD, APPARATUS AND DEVICE AS WELL AS MOBILE CARRIER

(71) Applicant: AAC Acoustic Technologies (Shanghai) Co., Ltd., Shanghai (CN)

(72) Inventors: Bing Zhao, Shanghai (CN); Wanli Xu, Shanghai (CN); Xuejing Sun, L.A., CA (US)

(21) Appl. No.: 19/294,363

(22) Filed: Aug. 8, 2025

Related U.S. Application Data
(63) Continuation of application No. PCT/CN2025/094541, filed on May 13, 2025.

(51) Int. Cl. G10K 11/178; G06T 7/70

(52) U.S. Cl. CPC G10K 11/17817; G06T 7/70; G10K 11/17823; G10K 11/17825; G10K 11/17881; G06T 2207/30201; G06T 2207/30268; G10K 2210/12821; G10K 2210/3012; G10K 2210/3026; G10K 2210/3027; G10K 2210/3028; G10K 2210/3038; G10K 2210/3055

(57) ABSTRACT

Provided is noise reduction method applied to mobile carrier, and method includes: continuously acquiring first environmental noise signal through first audio acquisition device, and inputting first environmental noise signal into first filter to generate first noise reduction signal; obtaining noise reduction signal at current moment, and outputting noise reduction signal through audio signal output device; and in process that audio signal output device continuously outputs noise reduction signals, generating first filter coefficient according to positions of ear of listener in mobile carrier and audio signal output device, and adjusting first filter. noise reduction method according to present disclosure simplifies system structure, reuses elements on existing carrier, and reduces overall cost; method of combining feedforward and feedback is adopted, so that noise reduction capability is improved; output noise reduction signal can be adjusted in real time according to position of listener, thus maintaining stability of noise reduction effect.

### TECHNICAL FIELD

The present disclosure relates to the technical field of acoustics and, in particular, to a noise reduction method, apparatus and device as well as a mobile carrier.

### BACKGROUND

In modern automotive industry, driving comfort is of great concern, the level of noise in a vehicle is a critical influencing factor, and road noise generated by road excitation accounts for a large proportion in the noise. Existing active road noise control systems mostly depend on accelerometers, a plurality of accelerometers are usually mounted at key parts, such as a part near a vehicle suspension and a vehicle body, so as to detect vibration excitation signals in real time, and then, reverse signals are generated with a feedforward adaptive method according to coherence of vibration and target noise to counteract the noise of a target region, and the road noise is reduced to a certain extent. However, in practical applications, the system has defects. On the one hand, a structure is complex. Signal accuracy is greatly influenced by the mounting position and angle of the accelerometer, higher mounting precision is required, and subsequent maintenance difficulty is high. On the other hand, a cost is high, the accelerometers and related sensors are expensive, and the total cost of the system is greatly increased by the plurality of accelerometers and related sensors, so that a heavy economic burden is brought in large-scale production and applications. In summary, although the existing active road noise control system based on the accelerometer has a good effect, requirements are difficult to meet due the structure and cost problems.

### SUMMARY

Embodiments of the present disclosure provide a noise reduction method, apparatus and device as well as a mobile carrier, which are intended to solve the problems that an existing vehicle noise reduction manner depends on an accelerometer, a device required for noise reduction is complex, maintenance difficulty is high, and a cost is high.

Based on the foregoing problems, in a first aspect, an embodiment of the present disclosure provides a noise reduction method applied to a mobile carrier, wherein the mobile carrier is provided with a first audio acquisition device, a second audio acquisition device and an audio signal output device, and the method includes:
continuously acquiring first environmental noise signal through the first audio acquisition device, and inputting the first environmental noise signal into a first filter to generate a first noise reduction signal;
superposing the first noise reduction signal and a second noise reduction signal which are currently generated to obtain a noise reduction signal at a current moment, and outputting the noise reduction signal through the audio signal output device;
the second noise reduction signal is obtained by performing noise reduction on an error audio signal, and the error audio signal is generated by superposing a noise reduction signal output by the audio signal output device at a previous moment and a second environmental noise signal acquired by the second audio acquisition device at the previous moment; and
in the process that the audio signal output device continuously outputs the noise reduction signals, generating a first filter coefficient according to positions of the ear of a listener in the mobile carrier and the audio signal output device, and adjusting the first filter.

With reference to the first aspect, in a possible implementation, the first noise reduction signal has an opposite phase to and a same amplitude as the first environmental noise signal;
the second noise reduction signal has an opposite phase to and a same amplitude as the error audio signal.

With reference to the first aspect, in a possible implementation, the noise reduction is performed on the error audio signal to obtain the second noise reduction signal in the following manner:
inputting the error audio signal into a second filter to generate the second noise reduction signal;
the method further includes:
in the process that the audio signal output device continuously outputs the noise reduction signals, determining a second filter coefficient of the second filter according to a real-time speed of the mobile carrier and an acoustic feature of the first environmental noise signal acquired in real time, and adjusting the second filter.

With reference to the first aspect, in a possible implementation, the determining a second filter coefficient of the second filter according to a real-time speed of the mobile carrier and an acoustic feature of the first environmental noise signal acquired in real time includes:
acquiring the real-time speed of the mobile carrier and the acoustic feature of the first environmental noise signal acquired in real time, and inputting the real-time speed and the acoustic feature into a preset scenario recognition model; and
determining a corresponding filter coefficient as the second filter coefficient according to scenario information output by the preset scenario recognition model;
the preset scenario recognition model is a neural network model which is trained in advance and configured to predict a scenario where the mobile carrier is located by taking speed information of the mobile carrier and an acoustic feature of an environmental noise signal as input; the filter coefficient is determined according to a pre-established corresponding relationship between different scenarios and filter coefficients.

With reference to the first aspect, in a possible implementation, the preset scenario recognition model is trained in the following manner:
constructing the preset scenario recognition model; and
taking a plurality of sets of sample data containing speed information of the mobile carrier and acoustic features of environmental noise as input, taking scenario information corresponding to each set of sample data as a true value, and training the preset scenario recognition model to obtain the trained preset scenario recognition model.

With reference to the first aspect, in a possible implementation, the in the process that the audio signal output device continuously outputs the noise reduction signals, generating a first filter coefficient according to positions of the ear of a listener in the mobile carrier and the audio signal output device, and adjusting the first filter includes:
determining a transfer function according to an acoustic transmission feature of a secondary path between the audio signal output device and the second audio acquisition device;
in the process that the audio signal output device continuously outputs the noise reduction signals, inputting the position of the ear of the listener and the first environmental noise signal determined in real time into the transfer function, and outputting a reference signal;
inputting the reference signal and the error audio signal into an adaptive filter to obtain the first filter coefficient of the first filter; and
adjusting the first filter using the first filter coefficient.

With reference to the first aspect, in a possible implementation, the position of the ear of the listener is determined by a preset computer vision algorithm.

In a second aspect, an embodiment of the present disclosure provides a noise reduction apparatus, including: a noise reduction module and a head tracking module;
the noise reduction module includes a first audio acquisition device, a second audio acquisition device and an audio signal output device;
the noise reduction module is configured to: continuously acquire first environmental noise signal through the first audio acquisition device, and input the first environmental noise signal into a first filter to generate a first noise reduction signal; and superpose the first noise reduction signal and a second noise reduction signal which are currently generated to obtain a noise reduction signal at a current moment, and output the noise reduction signal through the audio signal output device; wherein the second noise reduction signal is obtained by performing noise reduction on an error audio signal, and the error audio signal is generated by superposing a noise reduction signal output by the audio signal output device at a previous moment and a second environmental noise signal acquired by the second audio acquisition device at the previous moment; and
the head tracking module is configured to: in the process that the audio signal output device continuously outputs the noise reduction signals, generate a first filter coefficient according to positions of the ear of a listener in the mobile carrier and the audio signal output device, and adjust the first filter.

In a third aspect, an embodiment of the present disclosure provides a noise reduction device, including the noise reduction apparatus described in the second aspect.

In a fourth aspect, an embodiment of the present disclosure provides a mobile carrier, including the noise reduction device described in the third aspect.

The embodiments of the present disclosure have the following beneficial effects.

The embodiments of the present disclosure provide the noise reduction method, apparatus and device as well as the mobile carrier, which are applied to the mobile carrier. The mobile carrier is provided with the first audio acquisition device, the second audio acquisition device and the audio signal output device, and the method includes: continuously acquiring the first environmental noise signal through the first audio acquisition device, and inputting the first environmental noise signal into the first filter to generate the a first noise reduction signal; superposing the first noise reduction signal and the second noise reduction signal which are currently generated to obtain the noise reduction signal at the current moment, and outputting the noise reduction signal through the audio signal output device; wherein the second noise reduction signal is obtained by performing noise reduction on the error audio signal, and the error audio signal is generated by superposing the noise reduction signal output by the audio signal output device at the previous moment and the second environmental noise signal acquired by the second audio acquisition device at the previous moment; and in the process that the audio signal output device continuously outputs the noise reduction signals, generating the first filter coefficient according to the positions of the ear of the listener in the mobile carrier and the audio signal output device, and adjusting the first filter.

Compared with a method for detecting a road bumping degree by using an accelerometer to perform a noise reduction calculation in the related art, the noise reduction method according to the embodiment of the present disclosure simplifies a system structure, reuses elements on an existing carrier, and reduces an overall cost; a method of combining feedforward and feedback is adopted, so that a noise reduction capability is improved; in the embodiment of the present disclosure, the output noise reduction signal can be adjusted in real time according to the position of the listener, thus maintaining the stability of a noise reduction effect.

### BRIEF DESCRIPTION OF DRAWINGS

FIG. 1 is a flow chart of a noise reduction method according to an embodiment of the present disclosure;

FIG. 2 is a schematic structural diagram of a noise reduction apparatus according to an embodiment of the present disclosure; and

FIG. 3 is an example of an implementation scenario of the noise reduction method and the noise reduction apparatus according to the embodiments of the present disclosure.

### DESCRIPTION OF EMBODIMENTS

Embodiments of the present disclosure provide a noise reduction method, apparatus and device as well as a mobile carrier. The following describes preferred embodiments of the present disclosure in conjunction with the attached drawings in the specification. It should be understood that the preferred embodiments described herein are merely for illustration and explanation of the present disclosure, and are not intended to limit the present disclosure. The embodiments in the present application and features in the embodiments may be combined with each other without conflicts.

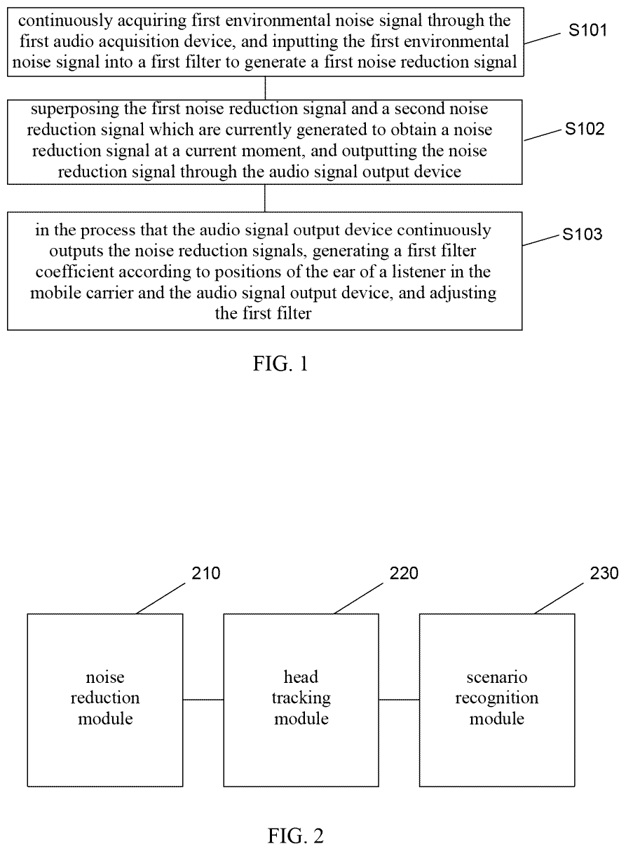

An embodiment of the present disclosure provides a noise reduction method applied to a mobile carrier, as shown in FIG. 1, wherein the mobile carrier is provided with a first audio acquisition device, a second audio acquisition device and an audio signal output device, and the method includes:
S101: continuously acquiring first environmental noise signal through the first audio acquisition device, and inputting the first environmental noise signal into a first filter to generate a first noise reduction signal;
S102: superposing the first noise reduction signal and a second noise reduction signal which are currently generated to obtain a noise reduction signal at a current moment, and outputting the noise reduction signal through the audio signal output device;
the second noise reduction signal is obtained by performing noise reduction on an error audio signal, and the error audio signal is generated by superposing a noise reduction signal output by the audio signal output device at a previous moment and a second environmental noise signal acquired by the second audio acquisition device at the previous moment; and
S103: in the process that the audio signal output device continuously outputs the noise reduction signals, generating a first filter coefficient according to positions of the ear of a listener in the mobile carrier and the audio signal output device, and adjusting the first filter.

The noise reduction method according to the embodiment of the present disclosure can be applied to the mobile carrier, and in the method, based on a sound wave destructive interference principle, the above noise reduction signal generation process is continuously executed to continuously generate sound waves opposite to noise to counteract the noise in the carrier, so as to reduce the noise heard by an occupant in an occupant compartment of the mobile carrier.

The first audio acquisition device may be a microphone for acquiring environmental noise, which may be configured to acquire a main noise signal during driving of the mobile carrier. The mobile carrier can be a manned vehicle, and various kinds of environmental noise can be generated during an actual driving process of the vehicle, and mainly include: engine noise, road noise, exhaust system noise, wind noise, or the like.

The first audio acquisition device may be arranged at locations near different noise sources in a targeted manner for different noise types. For acquisition of the engine noise, the first audio acquisition device may be arranged within an engine compartment; for acquisition of the wind noise, the first audio acquisition device can be arranged on a windward side of the vehicle; for acquisition of the road noise, a first audio acquisition device may be arranged on a vehicle chassis near tires.

According to actual needs, the number of the first audio acquisition devices arranged on the mobile carrier can be determined according to the type of the noise which needs to be eliminated in a targeted manner. For the situation where various types of noise need to be eliminated, a plurality of first audio acquisition devices can be correspondingly arranged to acquire various kinds of environmental noises for targeted noise reduction.

The original environmental noise signal of the first audio acquisition device is processed, then input, and subjected to a calculation of a noise reduction algorithm of the first filter, so as to generate the first noise reduction signal. Here, the processing of the original environmental noise signal may include: converting the original environmental noise signal into an electrical signal by the microphone (i.e., the first audio acquisition device), and then converting the electrical signal into a digital signal by an analog-to-digital converter, so as to facilitate the first filter to process the signal. In the embodiment of the present disclosure, an execution hardware subject for generating the noise reduction signal may be a digital signal processor (DSP) mounted on the mobile carrier. The first filter generates the corresponding first noise reduction signal according to the first environmental noise signal.

Further, the first noise reduction signal and the second noise reduction signal which are currently generated are superposed to obtain the noise reduction signal at the current moment, and after the digital signal is converted into an analog signal through a digital-to-analog converter, a corresponding audio signal is output through the audio signal output device to counteract the corresponding environmental noise signal. The audio signal output device may be a loudspeaker arranged in the occupant compartment of the mobile carrier. Taking the manned vehicle as an example, the audio signal output device may be an audio system including a headrest loudspeaker.

The second noise reduction signal is obtained by performing noise reduction algorithm processing on the error audio signal; the error audio signal may be an audio signal acquired by the second audio acquisition device after the noise reduction signal output by the audio signal output device at the previous moment and the second environmental noise signal are superimposed.

The signal noise reduction in the embodiment of the present disclosure is a cyclic process. The first audio acquisition device continuously acquires the first environmental noise signal and inputs the first environmental noise signal into the first filter. For the first noise reduction signal obtained for the first time, since the feedback second noise reduction signal is not generated, the first noise reduction signal can be output through the audio signal output device, the output noise reduction signal is superposed with the second environmental noise signal acquired by the second audio device to obtain the error audio signal, and then, noise reduction is performed on the error audio signal to obtain the second noise reduction signal. Since the first noise reduction signal is continuously generated by continuously performing noise reduction processing on the continuously acquired first environmental signals, while the second noise reduction signal is obtained, the new first noise reduction signal is obtained, the new first noise reduction signal and the currently obtained second noise reduction signal are superposed to obtain the noise reduction signal at the current moment, and then, the noise reduction signal is output through the audio signal output device, and the new error audio signal is continuously generated. The above process is repeatedly executed to realize the combination of feedforward and feedback, thereby improving a noise reduction capability.

The second audio acquisition device may be a microphone, and is configured to acquire a residual noise signal (i.e., the error audio signal) after the noise reduction in the occupant compartment of the mobile carrier, and feed the residual noise signal back to the noise reduction system, so as to improve a noise reduction effect.

The second audio acquisition device is generally arranged in the occupant compartment close to the occupant, and is configured to simulate a receiving condition of the audio signal by the occupant of the carrier. Taking the manned vehicle as an example, the second audio acquisition device may be arranged at a headrest of the occupant, a roof corresponding to the occupant, or the like.

Further, during practical applications, the noise heard by the occupant in the mobile carrier may be uneven due to the change in the position of the occupant, the direction of the head, or the motion state of the vehicle. In the embodiment of the present disclosure, the position of the ear of the occupant (i.e., the listener) in the carrier can be tracked in real time through a sensor, a noise propagation path is calculated in real time, and the generated noise reduction signal is adjusted by adjusting filter coefficients of noise reduction filters (i.e., the first filter and a second filter), so that the noise reduction effect at the ear of the occupant cannot be changed due to movement of the position of the occupant, or the like. The sensor may here be an existing sensor in the occupant compartment of the mobile carrier, for example: a driver monitor system (DMS), or the like.

In the embodiment of the present disclosure, the existing microphones (i.e., the first audio acquisition device and the second audio acquisition device) and the existing loudspeaker system (i.e., the audio signal output device) of the mobile carrier are utilized, and meanwhile, an existing power amplifier device of the carrier is reused, and only a certain computing device (e.g., the above mentioned DSP) is required to be added for active noise reduction, thus greatly reducing the cost of the system. The embodiment of the present disclosure can also ensure the stability of the noise reduction effect and improve the reliability of the system by a head tracking technology even if the position of the occupant in the carrier moves.

In another embodiment of the present disclosure, the first noise reduction signal has an opposite phase to and a same amplitude as the first environmental noise signal;
the second noise reduction signal has an opposite phase to and a same amplitude as the error audio signal.

In the embodiment of the present disclosure, the noise reduction signal may be generated based on the following formula (1).

$$y ( n ) = {\sum }_{k = 0}^{L - 1} {w}_{k} ( n ) \times x ( n - k ) \qquad ( 1 )$$

wherein L represents a sampling period range of the filter; y(n) represents the noise reduction signal generated at a period n; wₖ(n) represents the filter coefficient of a kth-order filter at the period n; x(n−k) represents an input noise signal before a kth period. The noise signal here may be the original environmental noise signal directly obtained from the noise source, or a noise signal estimated from the noise source and the noise propagation path. Here, an accurate counteracting signal is generated by capturing time-series features of noise signal historical values.

In another embodiment of the present disclosure, the noise reduction is performed on the error audio signal to obtain the second noise reduction signal in the following manner:
inputting the error audio signal into a second filter to generate the second noise reduction signal;
the method further includes:
step 1: in the process that the audio signal output device continuously outputs the noise reduction signals, determining a second filter coefficient of the second filter according to a real-time speed of the mobile carrier and an acoustic feature of the first environmental noise signal acquired in real time, and adjusting the second filter.

In the embodiment of the present disclosure, the error audio signal is input into the second filter, and the second filter may generate the corresponding second noise reduction signal according to the error audio signal. An ideal error audio signal should be an environmental sound with all noise signals removed. However, in practical applications, noise in the second environmental noise signal cannot be completely eliminated by the noise reduction signal, and a certain amount of noise still remains in the second environmental noise signal (i.e., the error audio signal) superimposed with the noise reduction signal. The corresponding second noise reduction signal is generated for the noise through the second filter, and after the second noise reduction signal is superposed with the currently generated first noise reduction signal, the audio signal output device outputs the new current noise reduction signal. By the method combining feedback and feedforward, the processing capacity for the noise signal is stronger, a better noise reduction effect can be provided, and the noise reduction capacity is obviously improved compared with a method only depending on feedforward to perform noise reduction in the related art.

Further, the error audio signal acquired by the second audio acquisition device may include normal environmental sounds (e.g., inter-occupant dialogue sounds and music sounds) in the occupant compartment of the mobile carrier in practical applications, and in order to keep the normal environmental sounds not counteracted as the noise signal, the second filter can selectively process a corresponding sound signal frequency band, only processes a noise dominant frequency band and reserves a voice frequency band; it is also possible to add a corresponding prefilter before the second filter to separate a voice content from a noise content in advance.

Further, most of the noise generated by the mobile carrier in the motion process has a relatively linear change rule and is regular, but a part of the noise is greatly influenced by environmental factors, and waveforms of the noise generated under different conditions have different features. Therefore, processing of this part of the generated noise influenced by various environmental factors is also an important content of the mobile carrier noise reduction system. Taking the manned vehicle as an example, the engine noise, the exhaust noise and the wind noise of the manned vehicle generally have a significant correlation with a driving speed; however, the road noise is affected by various factors including the driving speed, road conditions, weather conditions, tire conditions, or the like.

In the embodiment of the present disclosure, a special preset scenario recognition model is set for the noise greatly influenced by the environmental factors, and a corresponding scenario is determined through the acoustic feature of the acquired first environmental noise signal. Different second filter coefficients for the second filter are set in advance for different scenarios. When the mobile carrier is detected to be in the corresponding scenario, the second filter coefficient of the second filter is changed to correspond to the current scenario, so that the frequency domain response characteristic of the second filter to the corresponding noise signal can be improved, and the noise reduction capability is improved.

In the scenario recognition method in the embodiment of the present disclosure, the current scenario can be recognized and a noise reduction parameter (namely, the filter coefficient) can be automatically adjusted according to the input real-time speed and the noise feature, thus improving the adaptability and the noise reduction effect of the system. An existing speed sensor of the carrier can be utilized, an additional accelerometer is not required to be mounted, a system structure is simplified, and maintenance difficulty is reduced.

In another embodiment of the present disclosure, the determining a second filter coefficient of the second filter according to a real-time speed of the mobile carrier and an acoustic feature of the first environmental noise signal acquired in real time in step 1 may be performed as the following steps:
step 1: acquiring the real-time speed of the mobile carrier and the acoustic feature of the first environmental noise signal acquired in real time, and inputting the real-time speed and the acoustic feature into a preset scenario recognition model; and
step 2: determining a corresponding filter coefficient as the second filter coefficient according to scenario information output by the preset scenario recognition model;
the preset scenario recognition model is a neural network model which is trained in advance and configured to predict a scenario where the mobile carrier is located by taking speed information of the mobile carrier and an acoustic feature of an environmental noise signal as input; the filter coefficient is determined according to a pre-established corresponding relationship between different scenarios and filter coefficients.

In the embodiment of the present disclosure, a vehicle-mounted computing device mounted on the mobile carrier can execute the scenario recognition operation. The computing device acquires the first environmental noise signal acquired by the first audio acquisition device at the current moment and the real-time speed of the mobile carrier at the current moment, and inputs the two items into the preset scenario recognition model.

The preset scenario recognition model may be a neural network model, and the neural network model may predict and output the scenario where the mobile carrier is currently located with the speed of the mobile carrier and the acoustic feature of the noise signal as the input.

In another embodiment of the present disclosure, the preset scenario recognition model is trained in the following manner:
step 1: constructing the preset scenario recognition model; and
step 2: taking a plurality of sets of sample data containing speed information of the mobile carrier and acoustic features of environmental noise as input, taking scenario information corresponding to each set of sample data as a true value, and training the preset scenario recognition model to obtain the trained preset scenario recognition model.

In the embodiment of the present disclosure, training can be performed through a convolutional neural network, an input layer of the neural network receives vehicle speed data and acoustic feature vectors in the training process, and an output layer performs label classification on a predefined scenario. The acquired noise data may be subjected to short-time Fourier transform and a Mel frequency cepstral coefficient (MFCC) to extract an acoustic feature vector.

The predefined scenarios of different mobile carriers are different, and for example, the types of the predefined scenarios of the manned vehicle may include: a road state, a road material, or the like. Predetermined scenario tags thereof may be, for example: a dry asphalt road, a wet cement road, a snow unsurfaced road, etc., which are only examples and do not impose limitations.

In another embodiment of the present disclosure, the step S103 of in the process that the audio signal output device continuously outputs the noise reduction signals, generating a first filter coefficient according to positions of the ear of a listener in the mobile carrier and the audio signal output device, and adjusting the first filter may be performed as the following steps:
step 1: determining a transfer function according to an acoustic transmission feature of a secondary path between the audio signal output device and the second audio acquisition device;
step 2: in the process that the audio signal output device continuously outputs the noise reduction signals, inputting the position of the ear of the listener and the first environmental noise signal determined in real time into the transfer function, and outputting a reference signal;
step 3: inputting the reference signal and the error audio signal into an adaptive filter to obtain the first filter coefficient of the first filter; and
step 4: adjusting the first filter using the first filter coefficient.

In the embodiment of the present disclosure, an acoustic propagation path (i.e., the secondary path) between the audio signal output device and the second audio acquisition device may be affected by a physical propagation medium (e.g., air, a conductive structure, etc.), so as to affect the amplitude, phase, frequency, etc., of the noise reduction signal. If the influence of the secondary path is disregarded in the noise reduction signal generation process, a phase deviation between the noise reduction signal and the noise signal may be caused when the noise reduction signal reaches a target point (i.e., the ear of the listener or the second audio acquisition device), thereby reducing the noise reduction effect.

In the embodiment of the present disclosure, the transfer function is used to simulate the acoustic propagation feature of the secondary path, the first environmental noise signal processed by the transfer function is used as the reference signal and is input to the adaptive filter, and the first filter coefficient of the first filter is updated in combination with the error audio signal, so as to eliminate the influence of the physical medium on acoustic propagation, thereby improving the noise reduction effect. The transfer function can be determined with a frequency sweep method, a white noise method, or the like.

The adaptive filter may update the filter coefficient using the following formula (2).

w(n+1)=w(n)+μ×e(n)×x_{f}(n) (2)
wherein w(n) represents the filter coefficient at the period n; μ represents a step factor, and an updating amplitude of the filter coefficient can be changed by changing a value of the step factor; e(n) represents the error audio signal at the period n; x_{f}(n) represents the first environmental noise signal at the period n after processing by the transfer function; w(n+1) represents the filter coefficient at a period n+1 (i.e., the updated filter coefficient).

Similarly, the movement of the occupant in the mobile carrier may also change the acoustic propagation path from the audio signal output device to the ear, so that the noise reduction signal received by the ear cannot counteract the noise signal, thus reducing the noise reduction effect. Based on the same idea, the transfer function can be adjusted according to the movement of the occupant, so that the filter coefficient is changed to compensate the noise reduction effect. An example is provided herein to illustrate this compensation process. First, a camera of the occupant compartment of the carrier is moved to map the position of the ear of the listener into a physical propagation model of the predetermined secondary path; prestored transfer functions of different positions are predetermined in the physical propagation model; the camera captures the position of the ear of the listener in real time based on computer vision, or the like, and the position of the ear of the listener is adjusted in real time in the physical propagation model; and finally, the nearest prestored transfer function is selected according to the real-time position of the ear of the listener, and the current transfer function may also be generated with an interpolation algorithm. By changing the transfer function, the first filter coefficient of the first filter is changed, thereby compensating the noise reduction effect.

In another embodiment of the present disclosure, the position of the ear of the listener is determined by a preset computer vision algorithm.

An embodiment of the present disclosure further provides a noise reduction apparatus, as shown in FIG. 2, including: a noise reduction module 210 and a head tracking module 220;
wherein the noise reduction module 210 includes a first audio acquisition device, a second audio acquisition device and an audio signal output device; the noise reduction module 210 is configured to: continuously acquire first environmental noise signal through the first audio acquisition device, and input the first environmental noise signal into a first filter to generate a first noise reduction signal; and superpose the first noise reduction signal and a second noise reduction signal which are currently generated to obtain a noise reduction signal at a current moment, and output the noise reduction signal through the audio signal output device; wherein the second noise reduction signal is obtained by performing noise reduction on an error audio signal, and the error audio signal is generated by superposing a noise reduction signal output by the audio signal output device at a previous moment and a second environmental noise signal acquired by the second audio acquisition device at the previous moment; the first noise reduction signal has an opposite phase to and a same amplitude as the first environmental noise signal; the second noise reduction signal has an opposite phase to and a same amplitude as the error audio signal;
the noise reduction module 210 is further configured to input the error audio signal into a second filter to generate the second noise reduction signal;
the head tracking module 220 is configured to, in the process that the audio signal output device continuously outputs the noise reduction signals, generate a first filter coefficient according to positions of the ear of a listener in the mobile carrier and the audio signal output device, and adjust the first filter;
the head tracking module 220 is further configured to determine a transfer function according to an acoustic transmission feature of a secondary path between the audio signal output device and the second audio acquisition device; in the process that the audio signal output device continuously outputs the noise reduction signals, input the position of the ear of the listener and the first environmental noise signal determined in real time into the transfer function, and output a reference signal; input the reference signal and the error audio signal into an adaptive filter to obtain the first filter coefficient of the first filter; and adjust the first filter using the first filter coefficient; wherein the position of the ear of the listener is determined by a preset computer vision algorithm.

The noise reduction apparatus according to the embodiment of the present disclosure further includes a scenario recognition module 230;
the scenario recognition module 230 is configured to, in the process that the audio signal output device continuously outputs the noise reduction signals, determine a second filter coefficient of the second filter according to a real-time speed of the mobile carrier and an acoustic feature of the first environmental noise signal acquired in real time, and adjust the second filter;
the scenario recognition module 230 is further configured to acquire the real-time speed of the mobile carrier and the acoustic feature of the first environmental noise signal acquired in real time, and input the real-time speed and the acoustic feature into a preset scenario recognition model; and determine a corresponding filter coefficient as the second filter coefficient according to scenario information output by the preset scenario recognition model; the preset scenario recognition model is a neural network model which is trained in advance and configured to predict a scenario where the mobile carrier is located by taking speed information of the mobile carrier and an acoustic feature of an environmental noise signal as input; the filter coefficient is determined according to a pre-established corresponding relationship between different scenarios and filter coefficients;
the preset scenario recognition model is trained by adopting the following method: constructing the preset scenario recognition model; and taking a plurality of sets of sample data containing speed information of the mobile carrier and acoustic features of environmental noise as input, taking scenario information corresponding to each set of sample data as a true value, and training the preset scenario recognition model to obtain the trained preset scenario recognition model.

The noise reduction module 210 in the embodiment of the present disclosure may include: the first audio acquisition device, the second audio acquisition device, the audio signal output device and a computing device mounted on the mobile carrier; the computing device may be an executing subject of the first filter, the second filter, the adaptive filter, the transfer function, or the like.

The head tracking module 220 may include a camera device for identifying the position of the ear of the listener and a computer device for calculating position data.

The scenario recognition module 230 may include a computer device that stores the scenario recognition model and performs scenario recognition.

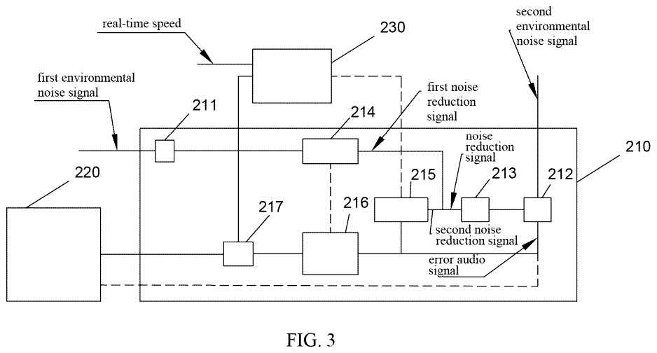

An example of an implementation scenario of the noise reduction method and apparatus according to the embodiments of the present disclosure is provided here, as shown in FIG. 3.

The first audio acquisition device 211 continuously acquires the first environmental noise signal, and the first environmental noise signal are subjected to analog-to-digital conversion and then input to the first filter 214, the transfer function 217, and the scenario recognition module 230 respectively. The first filter 214 performs a calculation on the input first environmental noise signal by using the noise reduction algorithm, and outputs the first noise reduction signal. The first noise reduction signal is superposed with the second noise reduction signal output by the second filter 215 to obtain the noise reduction signal at the current moment. The audio signal output device 213 acquires the noise reduction signal, performs digital-to-analog conversion, and outputs the noise reduction signal for noise reduction. The noise reduction signal is transmitted through the secondary path and then is superimposed with the second environmental noise signal at the second audio acquisition device 212, and the superimposed signal is acquired by the second audio acquisition device 212 to obtain the error audio signal. The error audio signal is input to the second filter 215 and the adaptive filter 216 respectively. The second filter 215 obtains the second noise reduction signal from the error audio signal and outputs the second noise reduction signal. The adaptive filter 216 respectively acquires the error audio signal and the reference signal obtained through the transfer function 217, and according to the above two signals, the adaptive filter 216 updates the first filter coefficient of the first filter 214 with an update algorithm, so as to provide a better noise reduction effect.

The scenario recognition module 230 determines the current scenario of the mobile carrier according to the real-time speed and the first environmental noise signal, and updates the second filter coefficient for the second filter 215 according to the predetermined corresponding relationship between the scenario and the second filter coefficient, so as to adapt to noise characteristics of different environments.

The head tracking module 220 acquires the position of the ear of the listener through the camera in real time, generates compensation data, and adjusts the transfer function 217, so as to change the first filter coefficient, realize the compensation of the noise reduction signal, and avoid that the noise reduction effect is reduced due to the change of the listener position.

An embodiment of the present disclosure further provides a noise reduction device, including the noise reduction apparatus according to the above embodiment.

An embodiment of the present disclosure further provides a mobile carrier, including the noise reduction device according to the above embodiment.

Through the above description of the embodiments, those skilled in the art may clearly understand that the embodiments of the present disclosure may be implemented by hardware, or by software plus a necessary general hardware platform. Based on such understanding, the technical solutions of the embodiments of the present disclosure may be embodied in the form of a software product, which may be stored in a non-volatile storage medium (which may be a CD-ROM, a USB disk, a removable hard disk, etc.), and includes several instructions for enabling a computer device (which may be a personal computer, a server, a network device, etc.) to execute the method according to the embodiments of the present disclosure.

Those skilled in the art may appreciate that the drawings are merely schematic diagrams of one preferred embodiment and that the modules or flows in the drawings are not necessary to implement the present disclosure.

Those skilled in the art can understand that the modules in the apparatus in the embodiment can be distributed in the apparatus in the embodiment according to the description of the embodiment, or located in one or more apparatuses different from the embodiment with corresponding changes. The modules in the above embodiments may be combined into one module, or further split into multiple sub-modules.

The above-mentioned serial numbers of the embodiments of the present disclosure are merely for description, and do not represent the priority of the embodiments.

It will be apparent that those skilled in the art can make various modifications and variations to the present disclosure without departing from the spirit and scope of the present disclosure. Thus, if these modifications and variations of the present disclosure fall within the scope of the claims and their equivalents of the present disclosure, it is intended that the present disclosure also encompasses such modifications and variations.

What is claimed is:

1. A noise reduction method, applied to a mobile carrier, wherein the mobile carrier is provided with a first audio acquisition device, a second audio acquisition device and an audio signal output device, and the method comprises:
continuously acquiring a first environmental noise signal through the first audio acquisition device, and inputting the first environmental noise signal into a first filter to generate a first noise reduction signal;
superposing the currently generated first noise reduction signal and a second noise reduction signal to obtain a noise reduction signal at a current moment, and outputting the noise reduction signal through the audio signal output device;
wherein the second noise reduction signal is obtained by performing noise reduction processing on an error audio signal, and the error audio signal is generated by superposing a noise reduction signal output by the audio signal output device at a previous moment and a second environmental noise signal acquired by the second audio acquisition device at the previous moment; and
during the audio signal output device continuously outputting the noise reduction signal, generating a first filter coefficient according to a position of an ear of a listener in the mobile carrier and a position of the audio signal output device, and adjusting the first filter.

2. The method as described in claim 1, wherein the first noise reduction signal has an opposite phase and a same amplitude as the first environmental noise signal; and
the second noise reduction signal has an opposite phase and a same amplitude as the error audio signal.

3. The method as described in claim 1, wherein the noise reduction processing is performed on the error audio signal to obtain the second noise reduction signal in the following manner:
inputting the error audio signal into a second filter to generate the second noise reduction signal; and
the method further comprises:
during the audio signal output device continuously outputting the noise reduction signal, determining a second filter coefficient of the second filter according to a real-time speed of the mobile carrier and an acoustic feature of the first environmental noise signal acquired in real time, and adjusting the second filter.

4. The method as described in claim 3, wherein the determining the second filter coefficient of the second filter according to the real-time speed of the mobile carrier and the acoustic feature of the first environmental noise signal acquired in real time comprises:
acquiring the real-time speed of the mobile carrier and the acoustic feature of the first environmental noise signal acquired in real time, and inputting the real-time speed and the acoustic feature into a preset scenario recognition model; and
determining the second filter coefficient according to scenario information output by the preset scenario recognition model;
the preset scenario recognition model is a neural network model which is trained in advance and takes speed information of the mobile carrier and the acoustic feature of the first environmental noise signal as inputs to predict a scenario where the mobile carrier is located; the filter coefficient is determined according to a pre-established corresponding relationship between different scenarios and filter coefficients.

5. The method as described in claim 4, wherein the preset scenario recognition model is trained in the following manner:
constructing the preset scenario recognition model; and
taking a plurality of sets of sample data containing the speed information of the mobile carrier and the acoustic feature of the first environmental noise signal as inputs, taking scenario information corresponding to each set of the sample data as a true value, and training the preset scenario recognition model to obtain the preset scenario recognition model after training.

6. The method as described in claim 1, wherein during the audio signal output device continuously outputting the noise reduction signal, the generating the first filter coefficient according to the position of the ear of the listener in the mobile carrier and the position of the audio signal output device and adjusting the first filter comprises:
determining a transfer function according to an acoustic transmission feature of a secondary path between the audio signal output device and the second audio acquisition device;
during the audio signal output device continuously outputting the noise reduction signal, inputting the position of the ear of the listener and the first environmental noise signal determined in real time into the transfer function, and outputting a reference signal;
inputting the reference signal and the error audio signal into an adaptive filter to obtain the first filter coefficient of the first filter; and
adjusting the first filter with the first filter coefficient.

7. The method as described in claim 6, wherein the position of the ear of the listener is determined by a preset computer vision algorithm.

8. A noise reduction apparatus, comprising: a noise reduction module and a head tracking module;
wherein the noise reduction module comprises a first audio acquisition device, a second audio acquisition device and an audio signal output device;
the noise reduction module is configured to: continuously acquire first environmental noise signal through the first audio acquisition device, and input the first environmental noise signal into a first filter to generate a first noise reduction signal; and superpose the currently generated first noise reduction signal and a second noise reduction signal to obtain a noise reduction signal at a current moment, and output the noise reduction signal through the audio signal output device;
wherein the second noise reduction signal is obtained by performing noise reduction processing on an error audio signal, and the error audio signal is generated by superposing a noise reduction signal output by the audio signal output device at a previous moment and a second environmental noise signal acquired by the second audio acquisition device at the previous moment; and
the head tracking module is configured to: during the audio signal output device continuously outputting the noise reduction signals, generate a first filter coefficient according to a position of an ear of a listener in the mobile carrier and a position of the audio signal output device, and adjust the first filter.

9. A noise reduction device, comprising the noise reduction apparatus according to claim 8.
